(19) United States
(12) Patent Application Publication
(10) Pub. No.: US 2026/0088976 A1
(43) Pub. Date: Mar. 26, 2026

(54) ACCELERATION OF CRYPTOGRAPHIC OPERATIONS

(71) Applicant: Xilinx, Inc., San Jose, CA (US)

(72) Inventors: Aman Gupta, Austin, TX (US); James Anderson, Albuquerque, NM (US); James D Wesselkamper, Albuquerque, NM (US); Ahmad R Ansari, San Jose, CA (US); Jason J Moore, Albuquerque, NM (US)

(73) Assignee: Xilinx, Inc., San Jose, CA (US)

(21) Appl. No.: 18/897,894

(22) Filed: Sep. 26, 2024

(51) Int. Cl. H04L 9/08; H04L 9/32

(52) U.S. Cl. CPC H04L 9/0825; H04L 9/3236

(57) ABSTRACT

A circuit arrangement includes a plurality of cryptographic accelerators. Each cryptographic accelerator is configured to perform cryptographic operations according to a respective cryptographic protocol. A first memory is coupled to the cryptographic accelerators. A first processor is configured to specify, in response to requests to perform the cryptographic operations, parameters to the cryptographic accelerators according to the requests. The first processor is configured to identify, in the first memory, keys that are associated with the cryptographic accelerators, and signal the cryptographic accelerators to commence performing the cryptographic operations according to the parameters and using the associated keys.

### TECHNICAL FIELD

The disclosure generally relates to systems having cryptographic support features.

### BACKGROUND

The AUTomotive Open System ARchitecture (AUTOSAR) is a result of collaboration between automotive manufacturers, suppliers and other companies from the electronics, semiconductor and software industries. The objective of the AUTOSAR is standardized software for automotive electronic control units (ECUs). The ECU performs real-time signal processing and implements other support functions, such as internet connectivity.

The increasing deployment of internet connectivity in vehicles makes them vulnerable to attacks. In an effort to protect against attacks, the ECU implements various cryptographic functions. However, the compute time required to complete a cryptographic operation can be much greater than the line rate for signal processing. In addition, cryptographic operations implemented as software executing on a processor may exceed power constraints in some applications.

### SUMMARY

A disclosed circuit arrangement includes a plurality of cryptographic accelerators. Each cryptographic accelerator is configured to perform cryptographic operations according to a respective cryptographic protocol. A first memory is coupled to the cryptographic accelerators. A first processor is configured to specify, in response to requests to perform the cryptographic operations, parameters to the cryptographic accelerators according to the requests. The first processor is configured to identify, in the first memory, keys that are associated with the cryptographic accelerators, and signal the cryptographic accelerators to commence performing the cryptographic operations according to the parameters and using the associated keys.

Another disclosed circuit arrangement includes a first plurality of cryptographic accelerators and a second plurality of cryptographic accelerators. The circuit arrangement includes a memory and one or more direct memory access (DMA) controllers coupled to the memory and to the first plurality of cryptographic accelerators. The circuit arrangement includes a first processor configured to, in response to requests to perform cryptographic operations from a plurality of agent processors, signal the first and second pluralities cryptographic accelerators to commence performing the cryptographic operations according to the requests. The one or more DMA controllers are configured to move data between the memory and the first plurality of cryptographic accelerators, and the second plurality of cryptographic accelerators is configured to bypass the one or more DMA controllers in moving data between the memory and the second plurality of cryptographic accelerators.

Other features will be recognized from consideration of the Detailed Description and Claims, which follow.

### BRIEF DESCRIPTION OF THE DRAWINGS

Various aspects and features of the circuits and methods will become apparent upon review of the following detailed description and upon reference to the drawings in which:

FIG. 1 shows a system having a security accelerator for improving performance and reducing power consumption in performing cryptographic operations on behalf of agent processors of the system;

FIG. 2 shows a flow diagram that illustrates the functional operation of inter-processor communication using an inter-processor interrupt channel;

FIG. 3 shows a flow diagram that illustrates the functional operation of line-rate a symmetric cryptographic operation through the DMA controllers of the security accelerator; and

FIG. 4 shows a flow diagram that illustrates generation of a key pair by the security accelerator.

### DETAILED DESCRIPTION

In the following description, numerous specific details are set forth to describe specific examples presented herein. It should be apparent, however, to one skilled in the art, that one or more other examples and/or variations of these examples, all of which are non-limiting, may be practiced without all the specific details given below. In other instances, well known features have not been described in detail so as not to obscure the description of the examples herein. For ease of illustration, the same reference numerals may be used in different diagrams to refer to the same elements or additional instances of the same element. Though the disclosed circuits and methods are described with reference to AUTOSAR environments, those skilled in the art will recognize that the disclosed approaches are applicable to applications in networking, data storage, blockchain etc.

The disclosed circuits and methods improve performance and reduce power consumption as compared to prior approaches. Higher performance and reduced power consumption are achieved by hardware implementations of cryptographic functions. That is, application-specific integrated circuitry, or specifically configured programmable logic implements the cryptographic functions. For example, the cryptographic circuits do not rely on embedded processors running the entire AUTOSAR stack or other software stack looking for acceleration. Agents making function calls for cryptographic operations can be software executing on embedded processors and/or programmable logic cores. Mechanisms for access control to the cryptographic functions allow the cryptographic hardware to be physically separated from adjacent untrusted agents. In addition, the hardware implements access controls that generate and store keys, which eliminates the need to wrap the keys. Notably, the hardened cryptographic circuitry provides policy enforcement and an isolated access control path, allowing access by future-developed application-specific programmable logic.

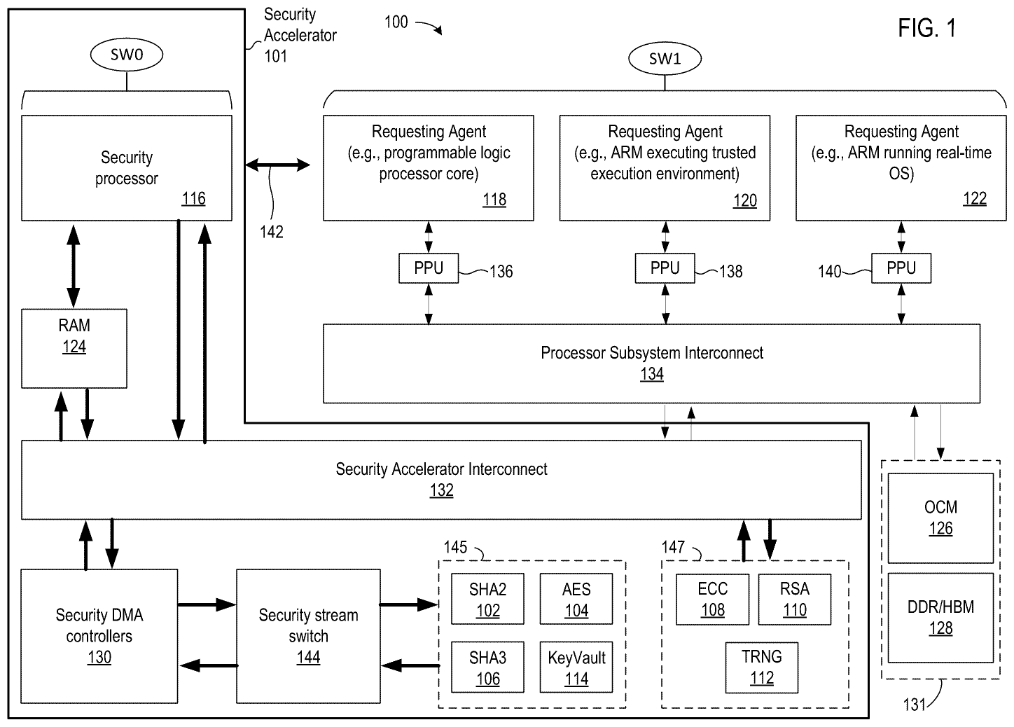

FIG. 1 shows a system 100 having a security accelerator 101 for improving performance and reducing power consumption in performing cryptographic operations on behalf of agent processors 118, 120, and 122 of the system. The system can be implemented as a system-on-chip (SoC) or system-in-chip (SiP), for example. Processors (or “agent processors” or “requesting agents”) 118, 120, and 122 are exemplary scalar processors or hardware accelerators that request services from the security accelerator 101. In an exemplary application, the agent processors can run the AUTOSAR software stack, offload cryptographic operations of the AUTOSAR stack, and/or make function calls for key-pair or session key generation without necessarily running the entire AUTOSAR software stack.

In an exemplary implementation, the agent processors can be implemented in programmable logic circuitry, hardwired logic circuitry, and/or a reduced instruction set computer (RISC). For example, agent processor 118 can be a scalar processor implemented in programmable logic and configured to execute the entire AUTOSAR software stack. The interface between agent processor 118 and security accelerator interconnect 132 can be physically isolated in a secure shell implemented in programmable logic. In addition, agent processor 118 can have a non-spoofable physical identifier (e.g., generated by a physically unclonable function (PUF)) by which security processor 116 and/or peripheral protection unit 136 can determine whether or not the requesting agent is permitted to send/retrieve key-pair or session key information.

Exemplary agent processors 120 and 122 can be hardwired, scalar processors capable of executing the entire AUTOSAR software stack. For example, agent processor 120 can be implemented as an Advanced RISC Microprocessor (ARM) configured to execute a trusted execution environment. Agent processor 122 can be implemented as an ARM configured to execute real time automotive applications. Agent processors 120 and 122 can be configured with all the isolation and firewalling capabilities described for requesting processor 118.

Security processor 116 can be a hardwired scalar processor, for example, a RISC-V core, configured to execute in a trusted execution environment and manage cryptographic functions requested by the agent processors 118, 120, and 122. In some implementations, security processor 116 can be dedicated to controlling the cryptographic accelerators. In an exemplary application the security processor can be configured to execute lower layers of the AUTOSAR stack in response to agent processors executing top layer of AUTOSAR software stack and requesting cryptographic operations.

Security processor 116 can be coupled to the agent processors 118, 120, 122 by respective interrupt signal channels 142. In making a request to the security accelerator to perform a cryptographic operation, an agent processor generates an interrupt signal to security processor and writes information pertinent to the request in memory 124. The information can include the type of the cryptographic operation (e.g., Advanced Encryption Standard (AES), Secure Hash Algorithm (SHA), Elliptic Curve Digital Signature Algorithm (ECDSA) etc.), operation parameters (e.g., keys, mode etc.), source and destination addresses for data access (e.g., double data rate (DDR) memory start and end address etc.). The interrupt channel allows for communication and coordination between the processors in the system, which enables the offloading of cryptographic operations and the exchange of data between the security processor 116 and the agent processors 118, 120, and 122. While the security accelerator 101 is processing a request, the requesting agent processor is free to execute other tasks while waiting for the operation to complete.

Processor 116 and its interface to the security accelerator interconnect 132 is physically isolated from the requesting agents 118, 120, and 120, whether those agents are executing trusted or untrusted code. Security processor 116 can also be configured to execute a trusted operating system in temporal lockstep mode in order to detect voltage glitch attacks seeking to discover generated keys or decrypted data.

In response to a request to perform cryptographic operations from an agent processor 118, 120, or 122, security processor 116 reads request information from memory 124 and specifies parameters to the appropriate cryptographic accelerator (102, 104, 106, 108, 110, or 112) according to the request. Examples of parameters for SHA2 include the operation type (SHA2-224, SHA2-256, SHA2-384, or SHA2-512 etc.); for SHA3 include the operation type (SHA3-224, SHA3-256, SHA3-384, or SHA3-512) etc.); for AES include key size, data, operation type (AES Counter mode or GCM or CBC etc.); for Elliptic-curve cryptography (ECC) and Rivest-Shamir-Adelman (RSA) include public private key pair, operation type (sign, multiply, point multiplication etc.); and for true random number generator (TRNG) a pseudo-random number count (a number of pseudo-random numbers to generate using a true random seed) etc.

Along with specifying parameters, security processor 116 identifies for the cryptographic accelerator particular keys, which are stored in memory 114 (“key vault”) and associated with the agent processor. The keys stored in memory 114 can include user keys, root keys of physically unclonable functions (PUFs), unwrapped/wrapped keys, and session keys for AES context switching. The memory 114 can be a dedicated and hardened key storage unit. The security processor 116 can import wrapped keys provided by the agent processors, unwrap the keys, and store the unwrapped keys in memory 114 to be used in subsequent cryptographic operations.

Once the security processor has provided the parameters and indicated which keys to obtain from the memory 114, the security processor signals the cryptographic accelerator to commence performing the cryptographic operations.

Security accelerator interconnect 132 is a circuit that facilitates communication between all components within the security accelerator 101, including the security processor 116, one or more direct memory access (DMA) controllers 130, and the cryptographic processors 102, 104, 106, 108, 110, and 112. The interconnect circuit physically isolates traffic pathways between components communicating in the trusted execution environment (security accelerator 101) and untrusted components (agent processors). Interconnect circuit 132 also propagates the non-spoofable physical identifiers of the agent processors to targeted cryptographic processors.

Interconnect circuit 132 is also structured such that the routing attributes of the interconnect that determine which traffic from which source and to which destination enforce that the paths traversed are authorized and physically isolated. The interconnect circuit can isolate the paths between two different sources and two destinations (same or different) by using a combination of interconnect and protection/isolation units, such as peripheral protection units (PPUs) 136, 138, and 140 or memory protection units (not shown). The isolation of paths provides context protection and protects against snooping. For example, requesting agent 122 (A4) and requesting agent 120 (A3) may attempt to access memory 124 via PPUs 140, 138, interconnect circuit 134, and interconnect circuit 132. To provide the desired isolation, memory 124 can be partitioned into non-overlapping address spaces designated for requesting agents 122 and 122, and the access paths can be isolated by configuring the PPUs and interconnect to restrict memory accesses to the assigned address ranges.

Security processor 116 can program DMA controllers 130 to facilitate reading data from and writing data to system memories 126 and 128 on behalf of cryptographic accelerators 102, 104, and 106. Memories 126 and 128 are both coupled to processor subsystem interconnect circuit 134, which is represented by dashed block 131. The DMA requests can be scatter-gather type to improve efficiency on non-contiguous Ethernet data fetched from Ethernet buffers. The system memories can be on-chip memory and/or external DDR memory. The security accelerator can include multiple DMAs to enable concurrent execution of multiple cryptographic operations on behalf of different ones of the requesting agents 118, 120 and 122, and thereby improve performance.

Security stream switch 144 is a hardened streaming interconnect between cryptographic accelerators 102, 104, and 106 and DMA controllers 130. Dashed block 145 signifies the coupling of cryptographic accelerators 102, 104, and 106 and the key vault memory 114 to the security stream switch. The cryptographic accelerators 102, 104, and 106 are coupled to the key vault memory 114 through stream switch 144. The switch has multiple streaming interfaces between multiple source-destination pairs and has programmable selection logic per use-case requirement.

The cryptographic accelerators 102, 104, 106, 108, 110, and 112 are configured to perform cryptographic operations according to respective, different cryptographic protocols/algorithms. The cryptographic accelerators are operable to concurrently perform the operations on behalf of different agent processors. For example, cryptographic accelerator 102 can perform cryptographic operations for agent processor 118, concurrent with cryptographic accelerator 104 performing cryptographic operations for agent processor 120, concurrent with cryptographic accelerator 108 performing cryptographic operations for agent processor 122. The cryptographic accelerators can be implemented as any suitable combination of hardwired logic circuits and programmable logic circuits, depending on application requirements and objectives.

In the exemplary system, cryptographic accelerators 102 and 106 implement cryptographic operations of the SHA2 and SHA3, respectively. The cryptographic accelerators 102 and 106 are dedicated authentication accelerators with post-quantum cryptographic support and mitigate side-channel attacks.

Cryptographic accelerator 104 implements cryptographic operations of a symmetric encryption algorithm such as the AES. The cryptographic accelerator supports block and stream ciphers with and without authentication and mitigates side-channel attacks.

The system 100 can also include cryptographic accelerators 108, 110, and 112 that implement an ECC algorithm, an RSA algorithm, and a TRNG, respectively. ECC and RSA are more compute intensive algorithms than SHA2, SHA3, and AES. Therefore, cryptographic accelerators 108 and 110 are configured to process data that is written to their local memories (not shown). Thus, the line rate bandwidth requirements of ECC and RSA are not very high. Cryptographic accelerators 108, 110, and 112 are all communicatively coupled to security accelerator interconnect circuit 132, which is represented by dashed block 147, providing access to memories 126 and 128.

Implementing the cryptographic operations and curves of all the cryptographic algorithms in application specific integrated circuitry (ASIC) would require extensive semiconductor area. Therefore, selected ones of the cryptographic accelerators can be implemented in programmable logic circuitry, and others of the cryptographic accelerators can be implemented in ASIC. The interface provided by the security processor 116 to the agent processors 118, 120, and 122 hides the details of the logic and ASIC/programmable logic implementation of the cryptographic accelerators from the application software executing on the agent processors. The combined implementation involving ASIC and programmable logic supports many more curves than would an ASIC-only implementation.

The peripheral protection units (PPUs) 136, 138, and 140 are circuits that control which agent processors can access which hardware resources through the processor subsystem interconnect 134. Each PPU circuit is configurable to restrict access by the coupled agent processor to the processor subsystem interconnect, memories 126 and 126, and components of the security accelerator 101. Each PPU can be configured to prevent the coupled agent processor from accessing keys in the key memory 114 that the agent processor is not authorized to access.

Interconnect circuit 134 facilitates communication between all the components in the system 100 outside the security accelerator 101. Interconnect circuit 134 physically isolates signal paths between components communicating in the trusted execution environment (within security accelerator 101) and components in the untrusted environment (components outside security accelerator 101). The non-spoofable physical identifiers of the agent processors are also communicated by the interconnect circuit 134 to the respective destinations. The routing attributes of the interconnect that determine which traffic from which source and to which destination enforce that the paths traversed are authorized and physically isolated.

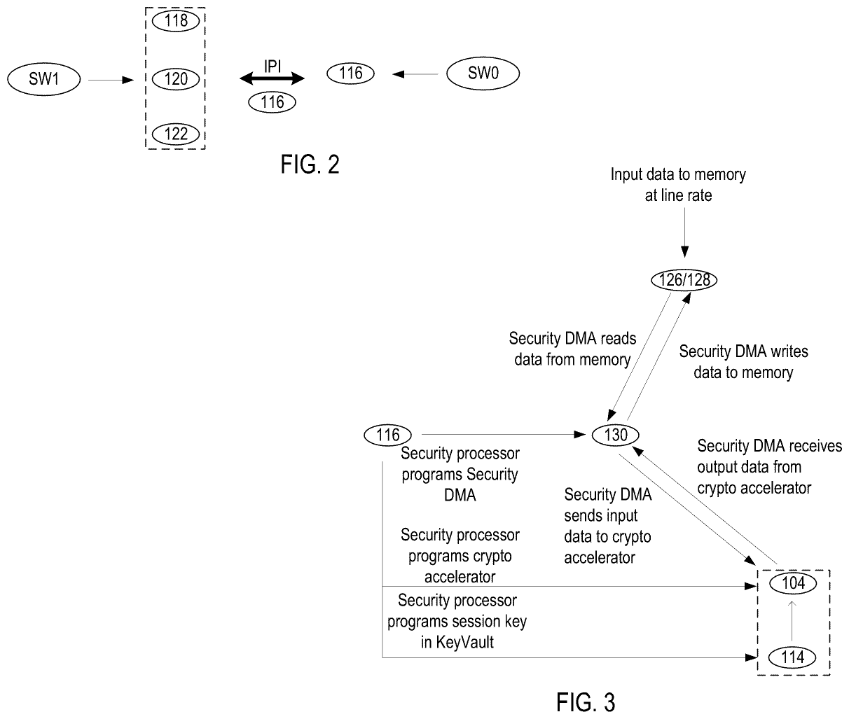

FIG. 2 shows a flow diagram that illustrates the functional operation of inter-processor communication using an inter-processor interrupt (IPI) channel. Trusted software SW1, executing on one of agent processors 118, 120, or 122, offloads instruction SW0, which requires acceleration, to security processor 116.

The agent processor issues an IPI request and writes instructions for processing the request to memory 124, which is dedicated to security processor 116. The IPI request triggers an interrupt to security processor 116, and security processor 116 starts executing the instructions from the tightly coupled memory 124. After completion of the request, security processor 116 writes the response in the same location in memory 124 and sends an IPI interrupt back to the agent processor.

FIG. 3 shows a flow diagram that illustrates the functional operation of a line-rate symmetric cryptographic operation through a DMA controller of the DMA controllers 130 of the security accelerator 101. Trusted software executing on security processor 116 programs DMA controller 130 to fetch data from a memory, such as memory 126 or 128. The memory 126/128 receives data from an external interface such as gigabit Ethernet or Controller Area Network with Flexible Data-Rate (CAN FD), for example. Security processor 116 programs DMA controller 130, programs AES parameters, and identifies a session key in the key memory 114, which is loaded in cryptographic accelerator 104 (AES engine). Once the DMA controller is programmed, security processor 116 triggers DMA controller 130 to read data from memory 126/128 and provide the data to cryptographic accelerator 104. Cryptographic accelerator 104 either encrypts or decrypts the data based on the instructions from security processor 116. The DMA controller receives the encrypted/decrypted data and writes the data to memory 126/128. The symmetric cryptographic accelerators are sized to meet performance and power constraints by way of widths of data paths and clock speeds. Similarly, buffers in interconnect circuits 132 and 134 are configured to pipeline the data read from external memories.

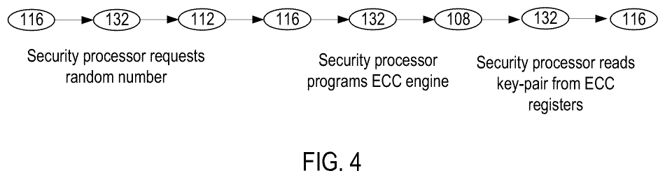

FIG. 4 shows a flow diagram that illustrates generation of a key pair by the security accelerator 101. Security processor 116 transmits a request for a random number to true random number generator 112 via security accelerator interconnect 132, and true random number generator 112 returns the random number to security processor 116 via the same interconnect. Security processor 116 programs ECC cryptographic accelerator 108 via security accelerator interconnect 132. ECC cryptographic accelerator 108 generates a key-pair based on the random number and writes the key-pair to local registers. Security processor 116 then reads the key-pair from the ECC registers.

Various logic may be implemented as circuitry to carry out one or more of the operations and activities described herein and/or shown in the figures. In these contexts, a circuit or circuitry may be referred to using terms such as “accelerator,” “controller,” “logic,” “module,” “engine,” “generator,” or “block.” It should be understood that elements labeled by these terms are all circuits that carry out one or more of the operations/activities. In certain implementations, a programmable circuit is one or more computer circuits programmed to execute a set (or sets) of instructions stored in a ROM or RAM and/or operate according to configuration data stored in a configuration memory.

Though aspects and features may in some cases be described in individual figures, it will be appreciated that features from one figure can be combined with features of another figure even though the combination is not explicitly shown or explicitly described as a combination.

The circuitry and methods are thought to be applicable to a variety of systems for accelerating cryptographic operations. Other aspects and features will be apparent to those skilled in the art from consideration of the specification. It is intended that the specification and drawings be considered as examples only, with a true scope of the invention being indicated by the following claims.

What is claimed is:

1. A circuit arrangement comprising:
a plurality of cryptographic accelerators (102, 104, 106, 108, 110, 112), wherein each cryptographic accelerator is configured to perform cryptographic operations according to a respective cryptographic protocol;
a first memory (114) coupled to the cryptographic accelerators; and
a first processor (116) configured to:
specify, in response to requests to perform the cryptographic operations, parameters to the cryptographic accelerators according to the requests;
identify, in the first memory, keys that are associated with the cryptographic accelerators; and
signal the cryptographic accelerators to commence performing the cryptographic operations according to the parameters and using the associated keys.

2. The circuit arrangement of claim 1, wherein the first processor is dedicated to controlling the cryptographic accelerators.

3. The circuit arrangement of claim 1, wherein the cryptographic accelerators are operable to concurrently perform the cryptographic operations.

4. The circuit arrangement of claim 1, wherein at least one of the cryptographic accelerators is a hardwired logic circuit.

5. The circuit arrangement of claim 1, wherein at least one of the cryptographic accelerators is a programmable logic circuit.

6. The circuit arrangement of claim 1, wherein the cryptographic accelerators include a first cryptographic accelerator configured to compute a cryptographic hash function on input data, and a second cryptographic accelerator configured to implement a symmetric encryption algorithm.

7. The circuit arrangement of claim 6, wherein the cryptographic accelerators include a third cryptographic accelerator configured to compute a random number, and a fourth cryptographic accelerator configured to implement an elliptic curve cryptography algorithm.

8. The circuit arrangement of claim 6, wherein the cryptographic accelerators include a third cryptographic accelerator configured to compute a random number, and a fourth cryptographic accelerator configured to implement a Rivest-Shamir-Adelman algorithm.

9. The circuit arrangement of claim 1, further comprising a second memory (126, 128) and one or more direct memory access (DMA) controllers coupled (130) to the first processor and the second memory, wherein the DMA controllers are configured to move data between the second memory and the cryptographic accelerators.

10. The circuit arrangement of claim 9, wherein the first processor is configured to program the one or more DMA controllers to provide input data from the second memory on which the cryptographic operations are to be performed, and program the one or more DMA controllers to write output data from the cryptographic accelerators to the second memory.

11. The circuit arrangement of claim 9, further comprising a first interconnect circuit (132) configured to communicatively couple the first processor, the one or more DMA controllers, and the cryptographic accelerators.

12. The circuit arrangement of claim 11, further comprising:
a plurality of agent processors (118, 120, 122) configured to communicate the requests to perform the cryptographic operations; and
a second interconnect circuit (134) configured to communicatively couple the first interconnect circuit, the plurality of agent processors, and the second memory.

13. The circuit arrangement of claim 12, further comprising protection circuits (136, 138, 140) coupled between the plurality of agent processors and the second interconnect circuit, wherein each protection circuit is configurable to restrict access to the first interconnect circuit and the second memory by a coupled agent processor of the plurality of agent processors.

14. The circuit arrangement of claim 12, wherein the first processor is coupled to the plurality of agent processors by respective interrupt signal lines.

15. The circuit arrangement of claim 12, wherein the plurality agent processors include a first agent processor (118) implemented in programmable logic and a second agent processor implemented as hardwired logic (120 or 122).

16. The circuit arrangement of claim 15, wherein the second agent processor is a reduced instruction set computer (RISC).

17. The circuit arrangement of claim 16, further comprising a third memory (124) coupled to the first processor, and to the plurality of agent processors, wherein the plurality of agent processors are configured to write the requests to the third memory.

18. The circuit arrangement of claim 12, wherein the first processor is configured to execute lower layers of an automotive open system architecture (AUTOSAR) stack, in response to the plurality of agent processors executing top layers of the AUTOSAR stack.

19. A circuit arrangement comprising:
a first plurality of cryptographic accelerators (102, 104, 106);
a second plurality of cryptographic accelerators (108, 110);
a memory (126, 128);
one or more direct memory access (DMA) controllers (130) coupled to the memory and to the first plurality of cryptographic accelerators; and
a first processor (116) configured to, in response to requests to perform cryptographic operations from a plurality of agent processors, signal the first and second pluralities cryptographic accelerators to commence performing the cryptographic operations according to the requests; and
wherein the one or more DMA controllers are configured to move data between the memory and the first plurality of cryptographic accelerators, and the second plurality of cryptographic accelerators is configured to bypass the one or more DMA controllers in moving data between the memory and the second plurality of cryptographic accelerators.

20. The circuit arrangement of claim 19, wherein the first plurality of cryptographic accelerators are configured to perform symmetric cryptographic operations according to respective cryptographic protocols, and the second plurality of cryptographic accelerators are configured to perform asymmetric cryptographic operations according to respective cryptographic protocols.
